(19) United States
(12) Patent Application Publication
(10) Pub. No.: US 2005/0225707 A1
(43) Pub. Date: Oct. 13, 2005

(54) Color filter substrate, display apparatus and method of manufacturing the same

(76) Inventors: Bong-Sung Seo, Yongin-si (KR); Dae-Ho Choo, Yongin-si (KR); Duck-Jong Suh, Seoul (KR)

Correspondence Address: McGuireWoods LLP;Suite 1800, 1750 Tysons Boulevard, McLean, VA, 22102, US

(21) Appl. No.: 11/086,914

(22) Filed: Mar. 23, 2005

(30) Foreign Application Priority Data
Apr. 12, 2004 (KR) 10-2004-0025022

(51) Int. Cl. G02F 1/1335

(52) U.S. Cl. 349/122

(57) ABSTRACT

In a display apparatus, a display panel displays an image and a first polarizer under the display panel polarizes a light applied to the display panel. A second polarizer on the display panel polarizes the light from the display panel. An absorbing layer between the first and second polarizers absorbs a first light from the first polarizer, having a predetermined wavelength, and provides a second light from the first polarizer to the second polarizer.

### CROSS-REFERENCE TO RELATED APPLICATION

This application claims priority to and the benefit of Korean Patent Application No. 10-2004-0025022, filed on Apr. 12, 2004, which is hereby incorporated by reference for all purposes as if fully set forth herein.

### BACKGROUND OF THE INVENTION

1. Field of the Invention

The present invention relates to a light absorbing layer, a display apparatus and a method of manufacturing the same. More particularly, the present invention relates to a a light absorbing layer that may improve display quality, a display apparatus having the light absorbing layer and a method of manufacturing the same.

2. Discussion of the Background

Generally, a liquid crystal display apparatus includes a liquid crystal display panel, an upper polarizing plate, a lower polarizing plate and a light source. The upper polarizing plate may be disposed on the liquid crystal display panel, and the lower polarizing plate may be disposed under the panel. The light source, which generates light, may be disposed under the lower polarizing plate. The liquid crystal display panel may comprise a color filter substrate, an array substrate facing the color filter substrate and a liquid crystal layer disposed between the substrates.

Applying an electric field to the liquid crystal layer defines the liquid crystal display panel's gray scale, which ranges from a black gray scale to a white gray scale. Applying a high electric field to the liquid crystal layer may brighten a screen of the liquid crystal display apparatus. Conversely, applying a low electric field to the liquid crystal layer may darken the apparatus' screen.

The upper polarizing plate and the lower polarizing plate have an upper polarizing axis and a lower polarization axis, respectively, which may be substantially perpendicular to each other. The upper polarizing plate absorbs a portion of a light that is substantially parallel with the upper polarization axis, and the lower polarizing plate absorbs a portion of a light that is substantially parallel with the lower polarization axis. Conventionally, the lower polarizing plate polarizes the light from the light source, and the liquid crystal display panel receives the polarized light from the lower polarizing plate. The liquid crystal layer varies characteristics of the polarized light, and this varied light is then provided to the upper polarizing plate, which polarizes the varied light.

When applying the high electric field to the liquid crystal layer, the light from the liquid crystal display panel may be converted into a light that may pass through the upper polarizing plate, so that the screen may display in the white gray scale. On the contrary, when applying the low electric field to the liquid crystal layer, the light from the liquid crystal display panel may be converted into a light that may not pass through the upper polarizing plate, so that the apparatus' screen may display in the black gray scale.

However, even though the upper polarizing plate's light transmittance may be near zero % as the electric field decreases, a light having a short wavelength may still pass through it. Consequently, a bluish image may be displayed on the screen due to this light leakage while the liquid crystal display panel operates in the black gray scale.

### SUMMARY OF THE INVENTION

The present invention provides a thin color filter substrate for improving display quality.

The present invention also provides a display apparatus having the above color filter substrate.

Additional features of the invention will be set forth in the description which follows, and in part will be apparent from the description, or may be learned by practice of the invention.

The present invention discloses a color filter substrate including a substrate, a color filter layer, an absorbing layer and a common electrode. The color filter layer is disposed on the substrate. The absorbing layer is disposed on the color filter layer to absorb a second light having a wavelength in a wavelength range of an externally provided first light. The common electrode is disposed on the absorbing layer.

The present invention also discloses a display apparatus comprising a display panel that displays an image, a first polarizer, a second polarizer and an absorbing layer. The first polarizer is disposed behind the display panel, and the second polarizer is disposed in front of the display panel. The first polarizer polarizes a first light applied to the display panel, and the second polarizer polarizes a second light from the display panel. The absorbing layer is disposed between the first polarizer and the second polarizer to absorb a light having a wavelength in a wavelength range of the polarized first light by the first polarizer.

The present invention also discloses a display apparatus including a color filter substrate, an array substrate, a first liquid crystal layer and a second liquid crystal layer. The color filter substrate has a first substrate, a color filter layer on the first substrate and a common electrode on the color filter layer. The array substrate has a second substrate, a thin film transistor array on the second substrate and a pixel electrode on the thin film transistor array. The first liquid crystal layer is disposed between the common electrode and the pixel electrode. The second liquid crystal layer is disposed between the first substrate and the second substrate to absorb a light having a wavelength in a wavelength range.

The present invention also discloses a method for manufacturing a color filter substrate. The method includes forming a color filter layer is on a substrate corresponding to a color area. An absorbing layer is formed on the color filter layer to absorb a light having a wavelength in a wavelength range. A common electrode is formed on the absorbing layer.

The present invention also discloses a method for manufacturing a display apparatus. The method comprises forming a color filter substrate having a first substrate, a color filter layer on the first substrate and a common electrode on the color filter layer. An array substrate having a second substrate, a thin film transistor array on the second substrate and a pixel electrode on the thin film transistor array is formed. A liquid crystal layer is disposed between the common electrode and the pixel electrode. An absorbing layer is formed between the first substrate and the second substrate to absorb a light having a wavelength in a wavelength range.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a cross-sectional view showing a color filter substrate according to an exemplary embodiment of the present invention.

FIG. 2 is a cross-sectional view showing a liquid crystal display apparatus according to another exemplary embodiment of the present invention.

FIG. 3 is a view showing a first polarizing plate and a second polarizing plate of FIG. 2.

FIG. 4 is a cross-sectional view showing a liquid crystal display apparatus according to another exemplary embodiment of the present invention.

FIG. 5 is a cross-sectional view showing an array substrate of FIG. 4.

FIG. 6 is a cross-sectional view showing a liquid crystal display apparatus according to another exemplary embodiment of the present invention.

FIG. 7 is a cross-sectional view showing a liquid crystal display apparatus according to another exemplary embodiment of the present invention.

FIG. 8A and FIG. 8B are cross-sectional views illustrating a method of forming a first absorbing layer on the color filter substrate of FIG. 1.

FIG. 9A and FIG. 9B are plan views showing the color filter substrate of FIG. 8A and FIG. 8B, respectively.

FIG. 10A and FIG. 10B are views illustrating a method of coating a first absorbing layer according to another exemplary embodiment of the present invention.

FIG. 11 is a cross-sectional view illustrating a method of coating a first absorbing layer according to another exemplary embodiment of the present invention.

FIG. 12 is a graph showing transmittance according to wavelength.

FIG. 13 is a graph showing transmittance according to wavelength while varying thickness of the first absorbing layer shown in FIG. 1.

FIG. 14 is a graph showing a chromaticity coordinate in a conventional liquid crystal display apparatus.

FIG. 15 is a graph showing a chromaticity coordinate in a liquid crystal display apparatus according to an exemplary embodiment of the present invention.

### DETAILED DESCRIPTION OF THE ILLUSTRATED EMBODIMENTS

Hereinafter, exemplary embodiments of the present invention will be explained in detail with reference to the accompanying drawings.

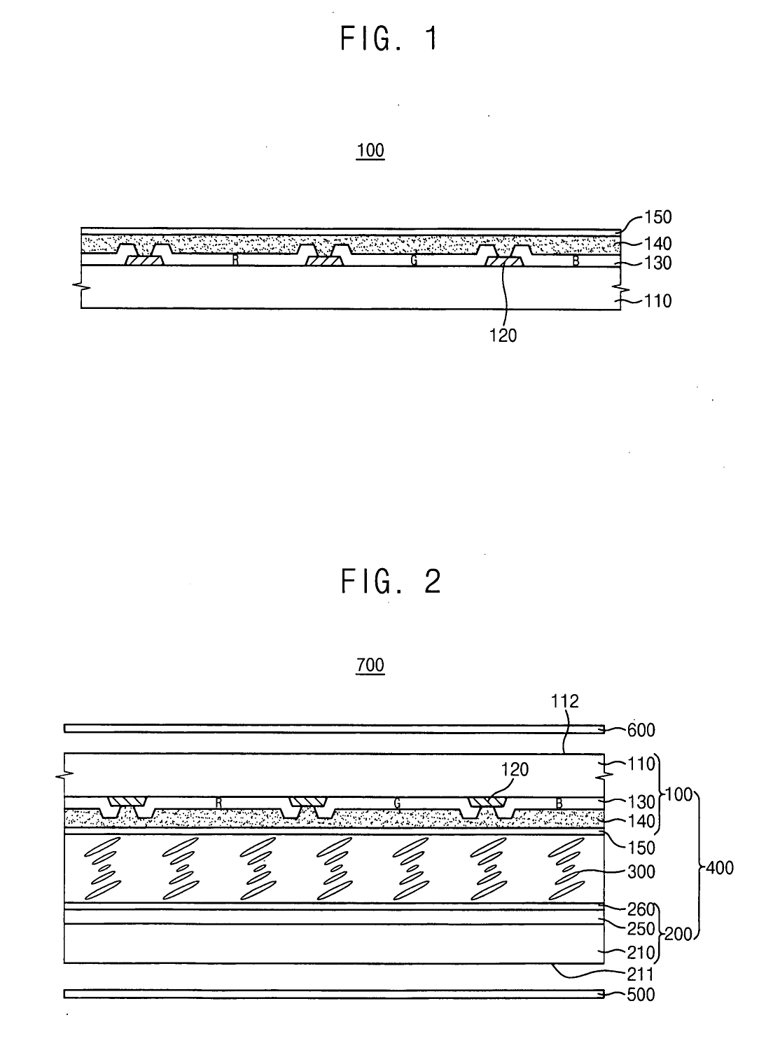

FIG. 1 is a cross-sectional view showing a color filter substrate according to an exemplary embodiment of the present invention.

Referring to FIG. 1, a color filter substrate 100 according to an exemplary embodiment of the present invention may include a first substrate 110, a color filter layer 130, a black matrix 120, a first absorbing layer 140 and a common electrode 150.

The first substrate 110 may comprise an insulating material, such as glass, ceramic, and other like materials. The color filter layer 130 has a red (R) pixel, a green (G) pixel and a blue (B) pixel, and it may be disposed on the first substrate 110. The black matrix 120 may be disposed between two differently colored, adjacent pixels to improve the pixels' color-reproducibility. The black matrix 120 may include an organic material, such as carbon, or a metal material, such as chromium (Cr) or chromium oxide (CrₓO_{y}).

The black matrix 120 extends along an end portion of the R, G and B color pixels adjacent to the black matrix 120 to prevent light leakage between the pixels. The R, G and B pixels partially overlap the black matrix 120, so that a step-difference occurs between the black matrix 120 and the pixels.

The first absorbing layer 140 may absorb a first light, having a wavelength in a first wavelength range, of a light supplied to the color filter substrate 100 while transmitting a second light having a wavelength in a second wavelength range, which may be longer than the first wavelength range. In the present exemplary embodiment, the first wavelength range is from about 380 nm to about 480 nm, and the second wavelength range includes wavelengths greater than about 480 nm. The first absorbing layer 140 has a liquid crystal molecule, and the layer may be coated on the black matrix 120 and the color filter layer 130.

The liquid crystal molecule may be represented by formulas (1), (2) and (3).

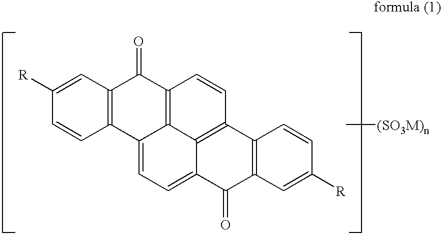

In formula (1), M denotes a cation (or positive ion) such as H⁺ or NH₄⁺, R denotes hydrogen (H), bromine (Br) or hydronitride aryl group (NHAr), and n is 2, 3 or 4.

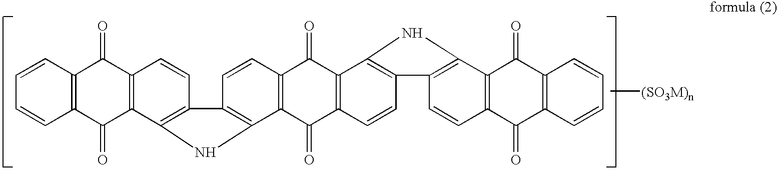

In formula (2), M denotes a cation (or positive ion) such as H⁺ or NH₄⁺, and n is 2, 3 or 4.

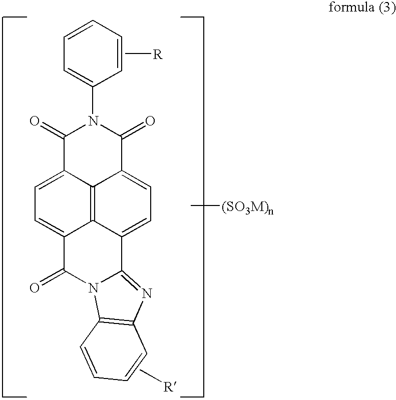

In formula (3), M denotes a cation (or positive ion) such as H⁺ or NH₄⁺, R and R′ independently denote hydrogen (H), halogen, alkyl group or aryl radical, and n is 2, 3 or 4.

The first absorbing layer 140 planarizes a surface of the color filter layer 130, thereby compensating for the step-difference between the R, G and B pixels and the black matrix 120. Thus, the first absorbing layer 140 may prevent the color filter substrate 100 from thickening.

The common electrode 150 is uniformly formed on the first absorbing layer 140. The common electrode 150 may comprise a transparent, conductive material, such as indium tin oxide (ITO) or indium zinc oxide (IZO).

FIG. 2 is a cross-sectional view showing a liquid crystal display apparatus according to another exemplary embodiment of the present invention. In FIG. 2, the same reference numerals denote the same elements in FIG. 1, and thus any further descriptions of the same elements will be omitted.

Referring to FIG. 2, a liquid crystal display apparatus 700 may include a color filter substrate 100, an array substrate 200 and a liquid crystal layer 300. The array substrate 200 faces the color filter substrate 100, and the liquid crystal layer 300 is disposed between the substrates.

Applying an electric field to the liquid crystal layer 300 determines a gray scale of a liquid crystal display panel 400. The gray scale may range from black to white. The liquid crystal display apparatus 700 displays an image in the white gray scale when applying a high electric field to the liquid crystal layer 300. On the contrary, it displays an image in the black gray scale when applying a low electric field to the liquid crystal layer 300. The array substrate 200 may include a second substrate 210, a thin film transistor (TFT) array 250 and a pixel electrode 260. The second substrate 210 includes an insulating material, such as glass or ceramic. The TFT array 250 may be formed on the second substrate 210. The TFT array 250, which will be explained in more detail with reference to FIG. 5, has a plurality of TFTs that are formed in a matrix shape.

The pixel electrode 260, which is uniformly formed on the TFT array 250, may comprise a transparent, conductive material such as ITO or IZO. The liquid crystal display apparatus 700 includes a first polarizing plate 500, which is disposed under the liquid crystal display panel 400, and a second polarizing plate 600, which is disposed on the liquid crystal display panel 400. The first polarizing plate 500 may be attached to a lower surface 211 of the second substrate 210 by a first adhesive member (not shown), such as an adhesive, an adhesive tape or other like fasteners. The second polarizing plate 600 may be attached to an upper surface 112 of the first substrate 110 by a second adhesive member, which may be the same as the first adhesive member.

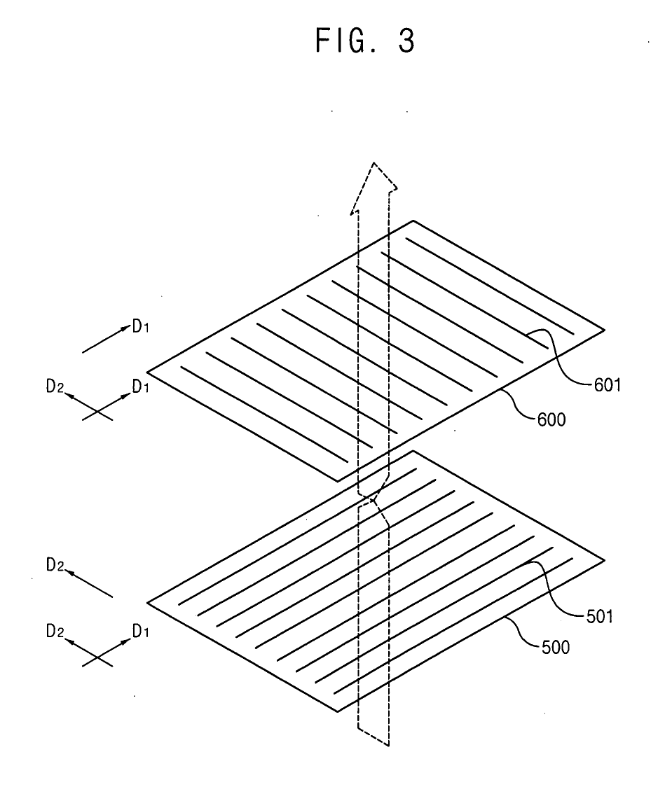

FIG. 3 is a perspective view showing the first and second polarizing plates of FIG. 2.

Referring to FIG. 3, the first polarizing plate 500 has a first polarizing axis 501, and the second polarizing plate 600 has a second polarizing axis 601. The first polarizing axis 501 extends in a first direction D1, and the second polarizing axis 601 extends in a second direction D2 that is substantially perpendicular to the first direction D1. The first polarizing plate 500 absorbs light components oscillating in the first direction D1 and transmits light components oscillating in the second direction D2. Conversely, the second polarizing pate 600 absorbs the light components oscillating in the second direction D2 and transmits the light components oscillating in the first direction D1.

The first polarizing plate 500 polarizes the light from a light source (not shown) positioned at a rear face of the first polarizing plate 500, thereby supplying polarized light to the liquid crystal display panel 400. The liquid crystal display panel 400 supplies components of the polarized light to the second polarizing plate 600, and the second polarizing plate 600 polarizes the light supplied from the liquid crystal display panel 400.

When the high electric field is applied to the liquid crystal layer 300, the light from the liquid crystal display panel 400 may pass through the second polarizing plate 600. Thus, the liquid crystal display panel 400 may display an image having a white gray scale. On the contrary, when the low electric field is applied to the liquid crystal layer 300, the light from the liquid crystal display panel 400 may not pass through the second polarizing plate 600. Thus, the liquid crystal panel 400 may display an image having a black gray scale.

The first absorbing layer 140 absorbs a first light, having a wavelength in a first wavelength range, of the light from the liquid crystal display panel 400 while transmitting a second light having a wavelength in a second wavelength range longer than the first wavelength range. The second polarizing plate 600 may then polarize the second light transmitted from the first absorbing layer 140.

In the present exemplary embodiment, the first absorbing layer 140 absorbs the first light, which may otherwise pass through the second polarizing axis 601 of the second polarizing plate 600, before the first light can be provided to the second polarizing plate 600. Thus, the liquid crystal display apparatus 700 may prevent the bluish image from being displayed on the liquid crystal display panel 400, thereby improving the panel's display quality.

In the case where the first polarizing axis 501 and the second polarizing axis 601 are substantially parallel to each other, the liquid crystal display apparatus 700 may still include the first absorbing layer 140.

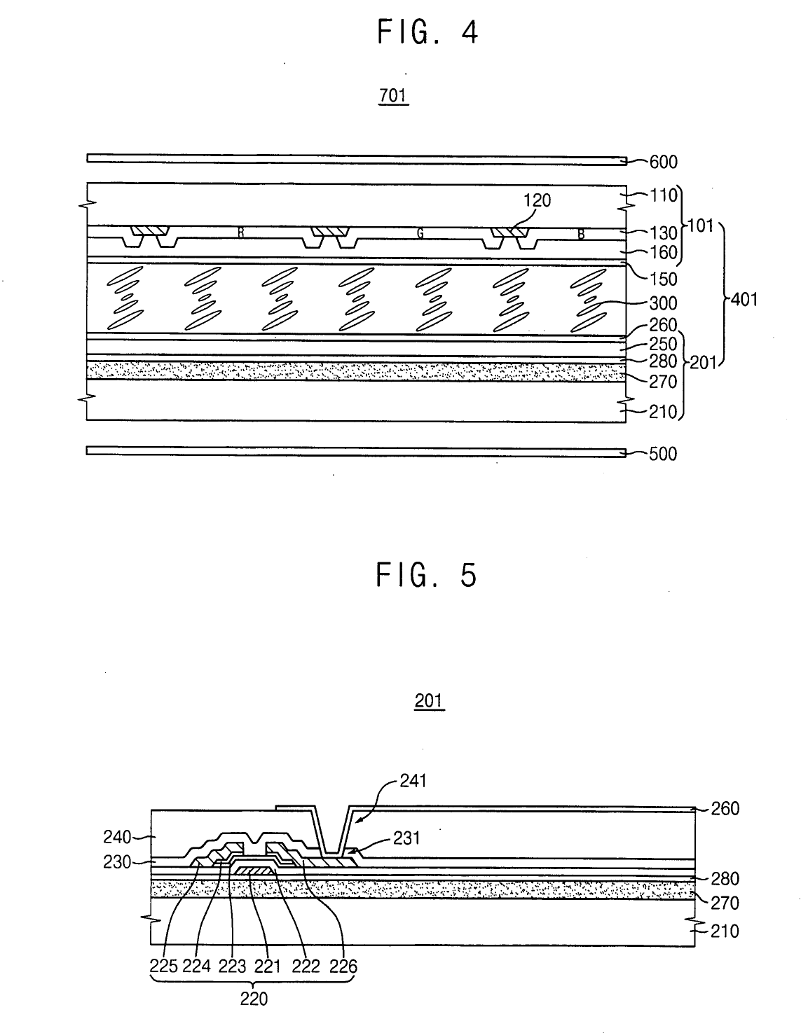

FIG. 4 is a cross-sectional view showing a liquid crystal display apparatus according to another exemplary embodiment of the present invention. FIG. 5 is a cross-sectional view showing an array substrate of FIG. 4.

Referring to FIG. 4, a liquid crystal display apparatus 701 may include a liquid crystal display panel 401, a first polarizing plate 500 and a second polarizing plate 600. The liquid crystal display panel 401 may comprise a color filter substrate 101 and an array substrate 201. The color filter substrate 101 may include a first substrate 110, a color filter layer 130, a black matrix 120, a planarization layer 160 and a common electrode 150. The planarization layer 160, which may include an organic material, planarizes a surface of the color filter substrate 101.

The array substrate 201 may include a second substrate 210, a second absorbing layer 270, a passivation layer 280, a TFT array 250 and a pixel electrode 260. The second absorbing layer 270 includes a plurality of liquid crystal molecules and is coated on the second substrate 210. The second absorbing layer 270 may absorb a first light, having a wavelength in a first wavelength range, of a light supplied to the liquid crystal display panel 400 while transmitting a second light having a wavelength in a second wavelength range longer than the first wavelength range. In the present exemplary embodiment, the first wavelength range is from about 380 nm to about 480 nm, and the second wavelength range includes wavelengths greater than about 480 nm.

The passivation layer 280 may protect the second absorbing layer 270 when forming the TFT array 250 on the array substrate 201.

As FIG. 5 shows, the TFT array 250 includes a plurality of TFTs 220 covered by first and second insulating layers 230 and 240.

Each of the TFTs 220 has a gate electrode 221, a gate insulating layer 222, an active layer 223, an ohmic contact layer 224, a source electrode 225 and a drain electrode 226.

The gate electrode 221 is disposed on the passivation layer 280, and the gate insulating layer 222 is disposed over the second substrate 210 having the gate electrode 221. The active layer 223 and the ohmic contact layer 224 are sequentially disposed on the gate insulating layer 222 corresponding to the gate electrode 221. The source and drain electrodes 225 and 226, which are spaced apart from each other by a predetermined distance, are disposed on the ohmic contact layer 224.

The first insulating layer 230 may cover the array substrate 201 having the TFT 220, and the second insulating layer 240 may be disposed on the first insulating layer 230. The first insulating layer 230 has a first contact hole 231, and the second insulating layer 240 has a second contact hole 241 corresponding to the first contact hole 231 to expose the drain electrode 226. In the present exemplary embodiment, the first and second insulating layers 230 and 240 include an inorganic material.

The pixel electrode 260 is uniformly formed on the second insulating layer 240, and it may be coupled to the drain electrode 226 through the first and second contact holes 231 and 241.

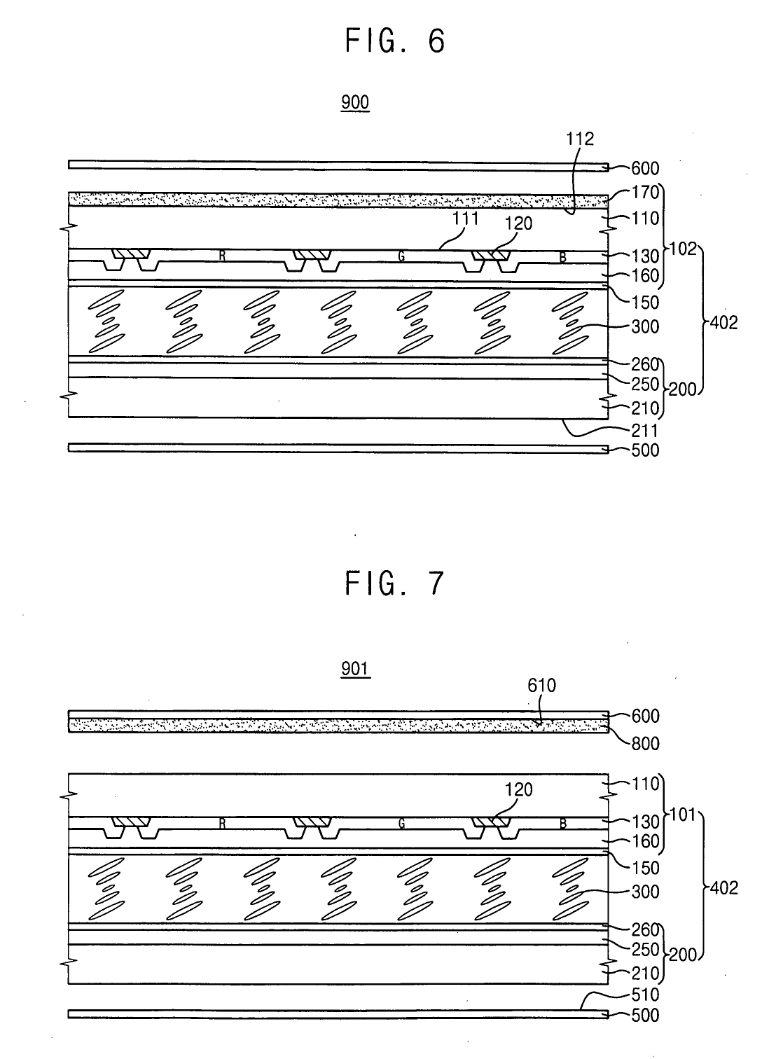

FIG. 6 is a cross-sectional view showing a liquid crystal display apparatus according to another exemplary embodiment of the present invention.

Referring to FIG. 6, a liquid crystal display apparatus 900 may include a liquid crystal display panel 402, a first polarizing plate 500 and a second polarizing plate 600.

The liquid crystal display panel 402 may have a color filter substrate 102 and an array substrate 200. The color filter substrate 102 may include a first substrate 110, a color filter layer 130, a black matrix 120, a planarization layer 160, a common electrode 150 and a third absorbing layer 170. The black matrix 120, the color filter layer 130, the planarization layer 160 and the common electrode 150 may be sequentially formed on a lower surface 111 of the first substrate 110. On the other hand, the third absorbing layer 170 may be coated on an upper surface 112 of the first substrate 110.

The third absorbing layer 170 may absorb a first light, having a wavelength in a first wavelength range, of a light from the first substrate 110 while transmitting a second light having a wavelength in a second wavelength range longer than the first wavelength range. In the present exemplary embodiment, the third absorbing layer 170 includes liquid crystal molecules to absorb the first light.

Although not shown in FIG. 6, the third absorbing layer 170 may be coated on a lower surface 211 of the second substrate 210 of the array substrate 200.

FIG. 7 is a cross-sectional view showing a liquid crystal display apparatus according to another exemplary embodiment of the present invention. In FIG. 7, the same reference numerals denote the same elements in FIG. 6, and thus any further detailed descriptions of the same elements will be omitted.

Referring to FIG. 7, a liquid crystal display apparatus 901 may include a liquid crystal display panel 402, a first polarizing plate 500, a second polarizing plate 600 and a fourth absorbing layer 800.

The fourth absorbing layer 800 may be coated on a lower surface 610 of the second polarizing plate 600. The fourth absorbing layer 800 may absorb a first light, having a wavelength in a first wavelength range, of a light from the liquid crystal display panel 402 while transmitting a second light having a wavelength in a second wavelength range longer than the first wavelength range.

Although not shown in FIG. 7, the fourth absorbing layer 800 may be coated on an upper surface 510 of the first polarizing plate 500.

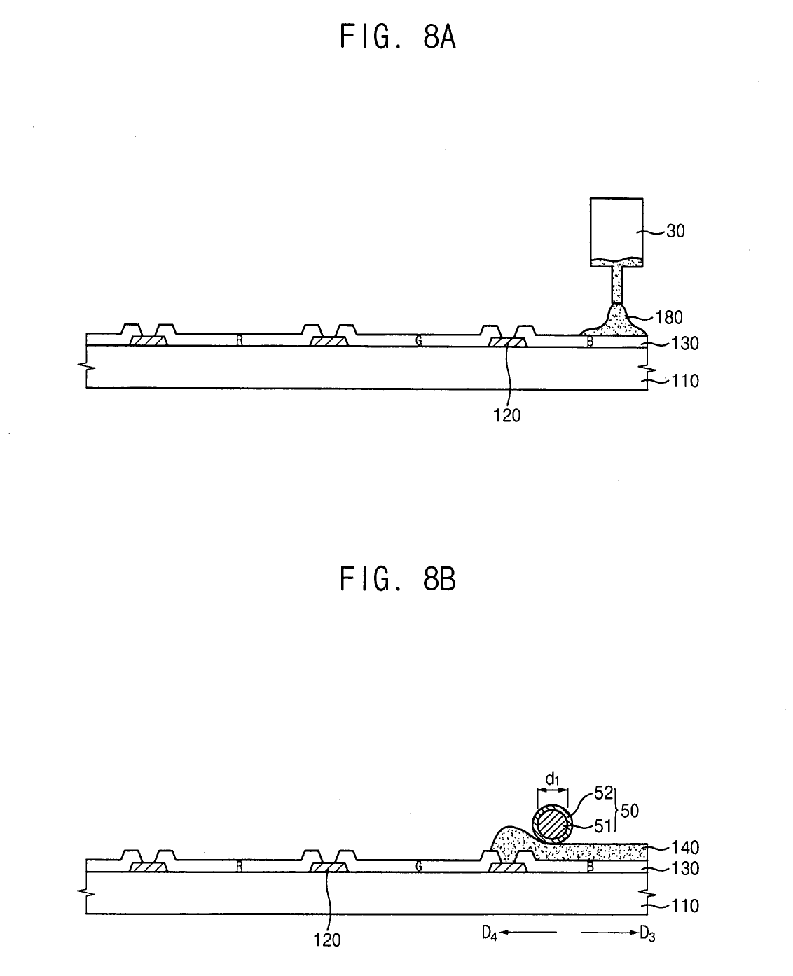

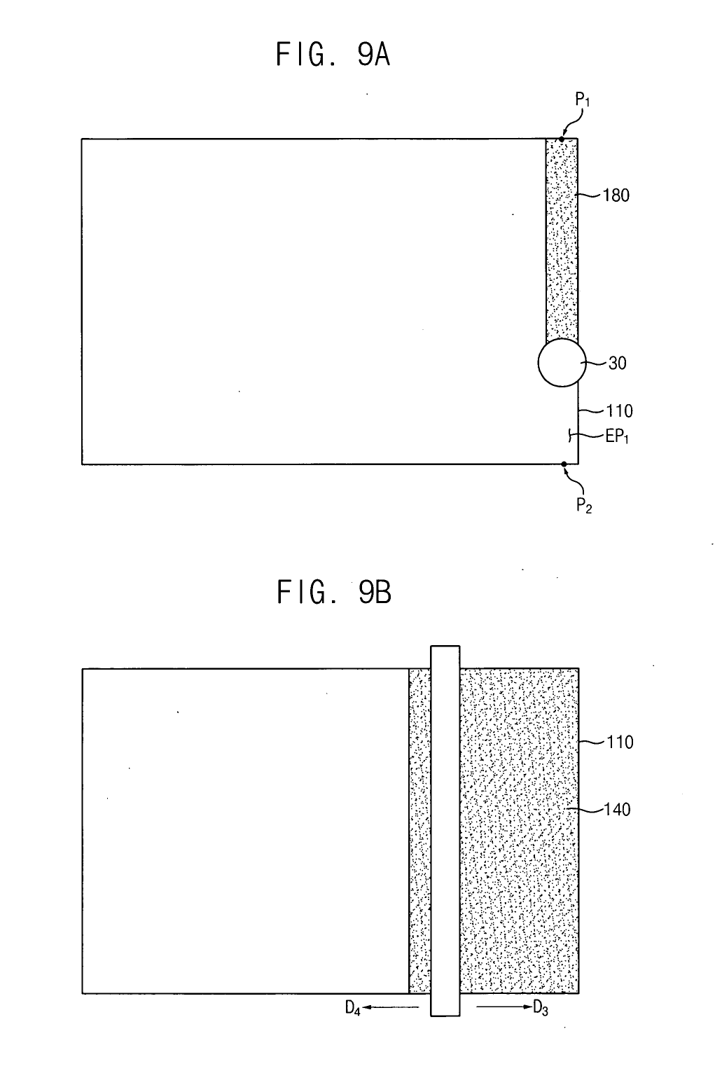

FIG. 8A and FIG. 8B are cross-sectional views illustrating a method of manufacturing a first absorbing layer on a color filter substrate. FIG. 9A and FIG. 9B are plan views showing the color filter substrate of the FIG. 8A and FIG. 8B, respectively.

Referring to FIG. 8A and FIG. 9A, a liquid crystal material 180 having liquid crystal molecules may be provided on a first end portion EP₁ of a first substrate 110 on which a black matrix 120 and a color filter layer 130 are formed. A provider 30 provides the liquid crystal material 180 while moving from a first point P₁ to a second point P₂ of the first end portion EP₁. As shown FIG. 8B and FIG. 9B, the first substrate 110 may move in a third direction D₃ with a predetermined speed after the roller 50 is placed on the liquid crystal material 180. The roller 50 may rotate and move in a fourth direction D₄, which is opposite to the third direction D₃, while the first substrate 110 moves in the third direction D₃. The roller 50 has a road 51 and a wire 52 that wraps the road 51. In the present exemplary embodiment, the road 51 has a diameter d₁ of about 20 mm.

The rolling roller 50 supplies the liquid crystal material 180 with stress, so that a flat, first absorbing layer 140 may be coated on the first substrate 110. In the present exemplary embodiment, when the first substrate 110 is about 10 cm×10 cm, the roller 50 may coat the first absorbing layer 140 at a speed in a range of about 20 mm/sec to about 180 mm/sec.

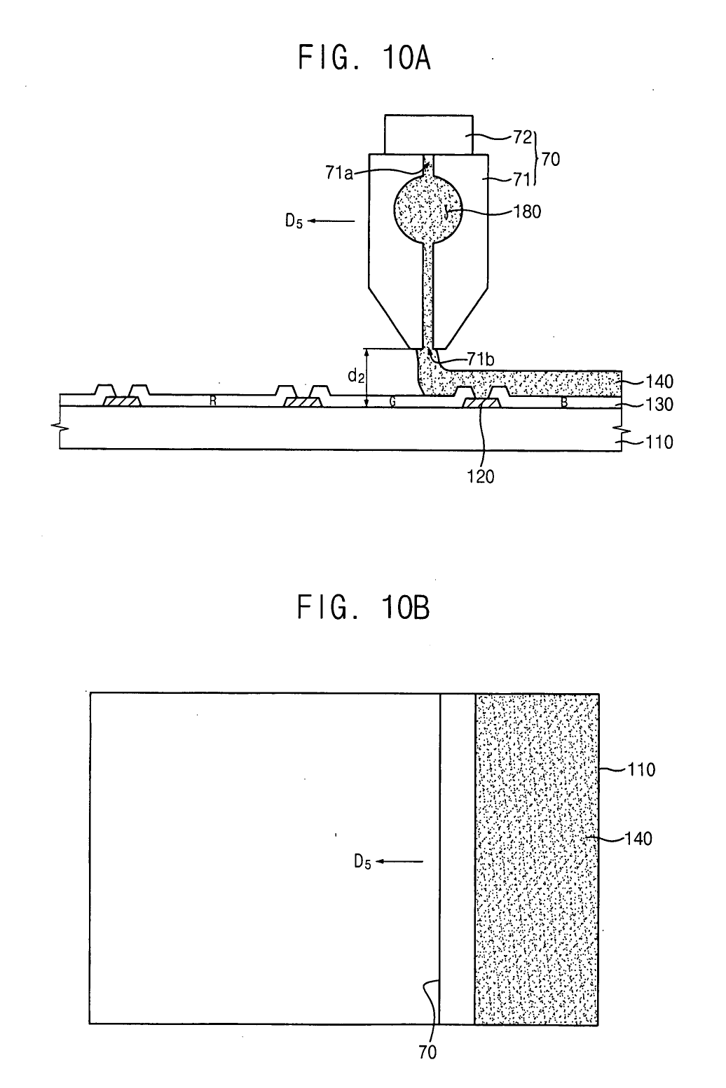

FIG. 10A and FIG. 10B are views illustrating a method of coating a first absorbing layer according to another exemplary embodiment invention.

Referring to FIG. 10A and FIG. 10B, a slit coater 70 may be disposed over a first substrate 110 on which a black matrix 120 and a color filter layer 130 are formed. The slit coater 70 coats the first absorbing layer 140 on the first substrate 110 while moving in a fifth direction D₅. The slit coater 70 has a slit nozzle 71 and a pump 72 that supplies the liquid crystal material 180 to the slit nozzle 71. The silt nozzle 71 has an inlet hole 71a, through which the liquid crystal material 180 is supplied, and an outlet hole 71b, through which the liquid crystal material 180 is discharged.

When the slit coater 70 moves in the fifth direction D₅, the liquid crystal material 180 stored in the slit nozzle 71 is supplied to the first substrate 110 through the outlet hole 71b. Therefore, the first absorbing layer 140 may be formed on the first substrate 110.

In the present exemplary embodiment, when the first substrate 110 is about 10 cm×10 cm, the slit coater 71 may move at about 40 mm/sec, and a distance d₂ between the slit coater 71 and the first substrate 110 may be about 30 um.

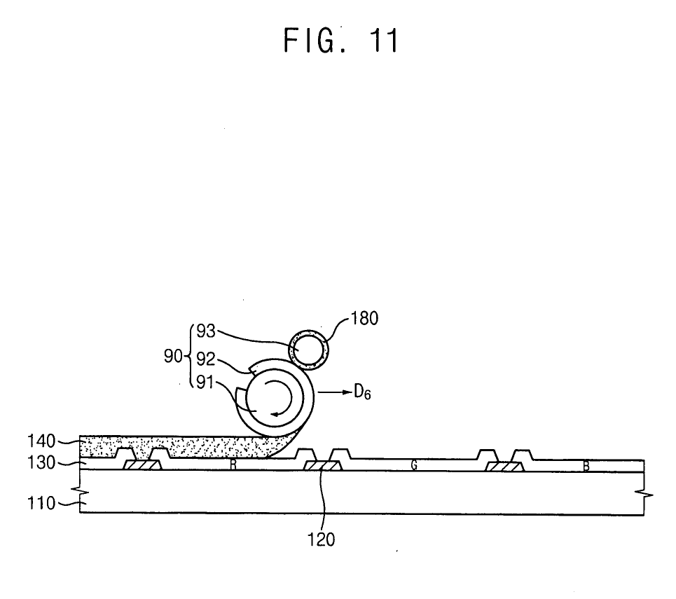

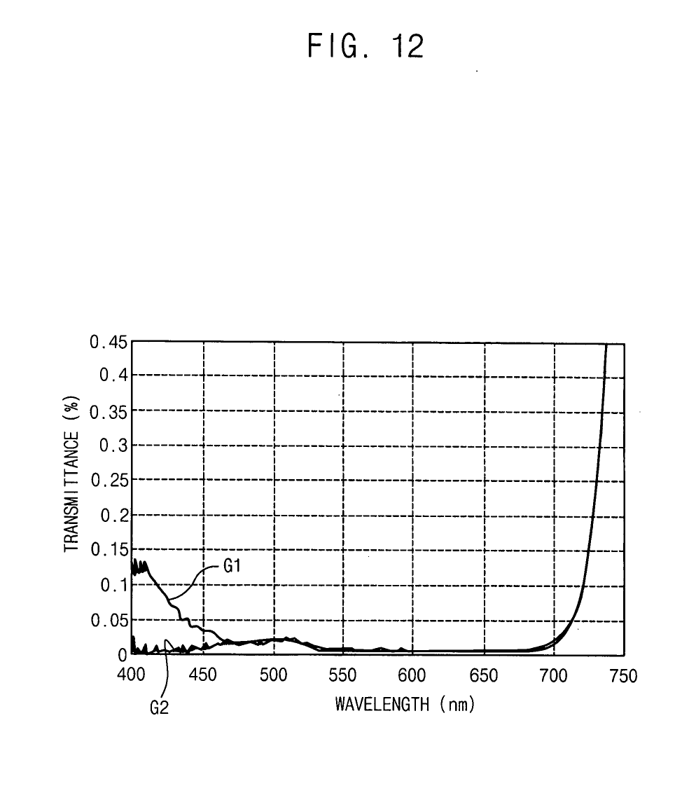

FIG. 11 is a cross-sectional view illustrating a method of coating a first absorbing layer according to another exemplary embodiment invention.

Referring to FIG. 11, a printing device 90 may be disposed over a first substrate 110 on which a black matrix 120 and a color filter layer 130 are formed. The printing device 90 includes a printing roller 91, a printing plate 92 and a transfer roller 93. The printing plate 92 is wrapped around an outer surface of the printing roller 91, and the transfer roller 93 transfers the liquid crystal material 180 to the printing plate 92.

The liquid crystal material 180 formed on the transfer roller 93 may transfer to a surface of the printing plate 92 while the printing roller 91, which rotates with a predetermined speed, moves in a sixth direction D₆. The liquid crystal material 180 transferred to the printing plate 92 may be coated on the first substrate 110 by the rotating printing roller 91. Therefore, the first absorbing layer 140 may be formed on the first substrate 110.

In the present exemplary embodiment, the printing device 90 may move faster than a speed at which the printing roller 91 rotates. Particularly, a difference between the speed at which the printing device 90 moves and the speed at which the printing roller 91 rotates may be about 20 mm/sec. Due to this speed difference, stress may be applied to the first absorbing layer 140 on the first substrate 110.

FIG. 12 is a graph showing transmittance according to wavelength. In FIG. 12, a first curve G1 represents transmittance of a conventional liquid crystal display apparatus, and a second curve G2 represents transmittance of a liquid crystal display apparatus according to an exemplary embodiment of the present invention. Also, an X-axis represents wavelength (nm) of a light, and a Y-axis represents light transmittance (%) with respect to the first and second polarizing plates. The conventional liquid crystal display apparatus has a first polarizing plate 500, which has a first polarizing axis 501, and a second polarizing plate 600, which has a second polarizing axis 601 that is substantially perpendicular to the first polarizing axis 501. Similarly, the liquid crystal display apparatus of the present invention has the first polarizing plate 500 having the first polarizing axis 501 and the second polarizing plate 600 having the second polarizing axis 601 substantially perpendicular to the first polarizing axis 501. Unlike the conventional apparatus, however, the liquid crystal display apparatus of the present invention also includes the absorbing layer between the first and second polarizing plates 500 and 600.

Referring to FIG. 12, as the first curve G1 shows, the transmittance of the light that has passed through the first and second polarizing plates of the conventional liquid crystal display apparatus is approximately 0% in a wavelength range of about 480 nm to about 700 nm. However, the transmittance of the light that has passed through the first and second polarizing plates 500 and 600 increases to about 0.14% in a wavelength range of about 400 nm to about 480 nm, and the transmittance rapidly increases in a wavelength range over about 700 nm.

Generally, a light source (not shown) of a liquid crystal display apparatus 700 generates light having a wavelength less than about 680 nm. Hence, the light transmittance in a wavelength greater than about 700 nm may not affect display quality of the liquid crystal display apparatus 700. However, light leakage may occur in a wavelength range of about 400 nm to about 480 nm as the light transmittance increases along the first curve G1. Consequently, a screen of the liquid crystal display apparatus 700 may be blued due to this light leakage.

In the liquid crystal display apparatus having the absorbing layer of the present embodiment, as the second curve G2 shows, transmittance of the light that has passed through the first and second polarizing plates 500 and 600 is approximately 0% in the wavelength range of about 400 nm to about 700 nm. This result is due to the absorbing layer, which may absorb light corresponding to the wavelength range of about 400 nm to about 480 nm.

Therefore, the liquid crystal display apparatus having the absorbing layer may prevent light leakage in the wavelength range of about 400 nm to about 480 nm, thereby improving the display quality of the liquid crystal display apparatus 700.

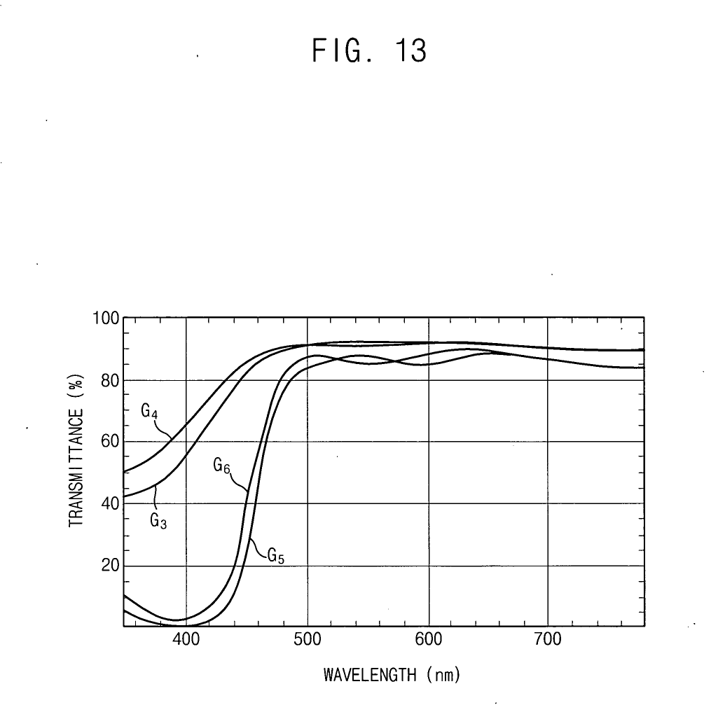

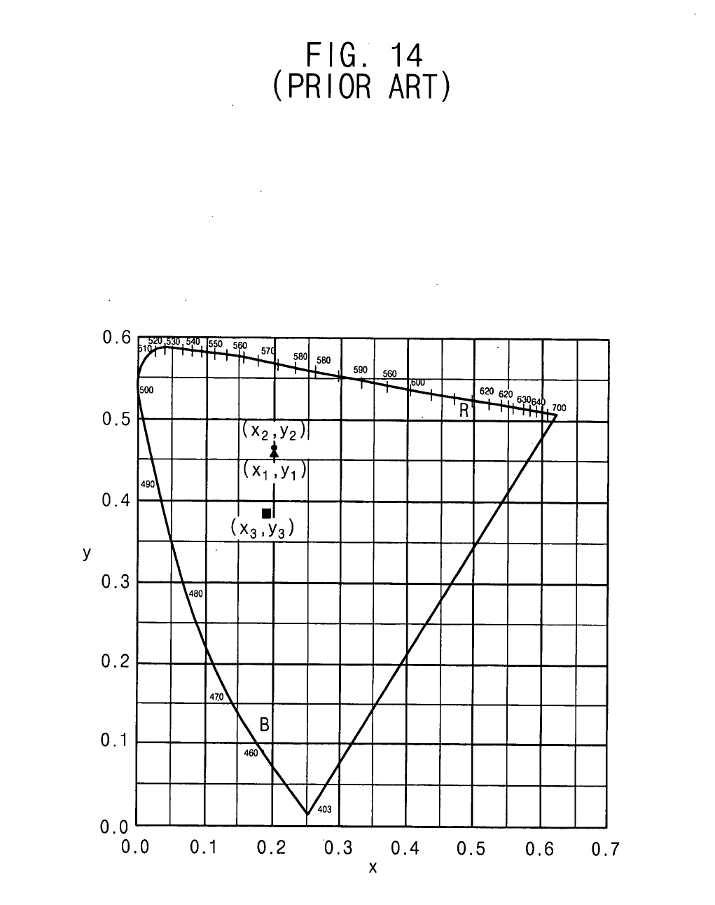

FIG. 13 is a graph showing transmittance versus wavelength according to a thickness of the first absorbing layer of FIG. 1. In FIG. 13, an X-axis represents a wavelength (nm) and a Y-axis represents a transmittance (%) of a light that has passed through first and second polarizing plates 500 and 600.

Referring to FIG. 13, a third curve G3 and a fourth curve G4 represent a light transmittance when the first polarizing axis of the first polarizing plate 500 is substantially parallel to the second polarizing axis of the second polarizing plate 600. The third curve G3 represents a light transmittance with about a 900 mm thick first absorbing layer 140, and the fourth curve G4 represents the light transmittance with about a 700 mm thick first absorbing layer 140. As FIG. 13 shows, light transmittance may rapidly decrease for wavelengths below about 500 nm, and it may decrease more rapidly when the first absorbing layer 140 is about 900 mm thick than when it is about 700 mm thick.

In FIG. 13, a fifth curve G5 and a sixth curve G6 represent light transmittance when the first polarizing axis 501 of the first polarizing plate 500 is substantially perpendicular to the second polarizing axis 601 of the second polarizing plate 600. The fifth curve G5 represents light transmittance with about a 900 mm thick first absorbing layer 140, and the sixth curve G6 represents light transmittance with about a 700 mm thick first absorbing layer 140. As FIG. 13 shows, light transmittance may rapidly decrease when the wavelength is in a range of about 380 nm to about 480 nm, and it may decrease more rapidly when the first absorbing layer 140 is about 900 mm thick than when it is about 700 mm thick.

Consequently, the first absorbing layer 140 may absorb more light as it thickens.

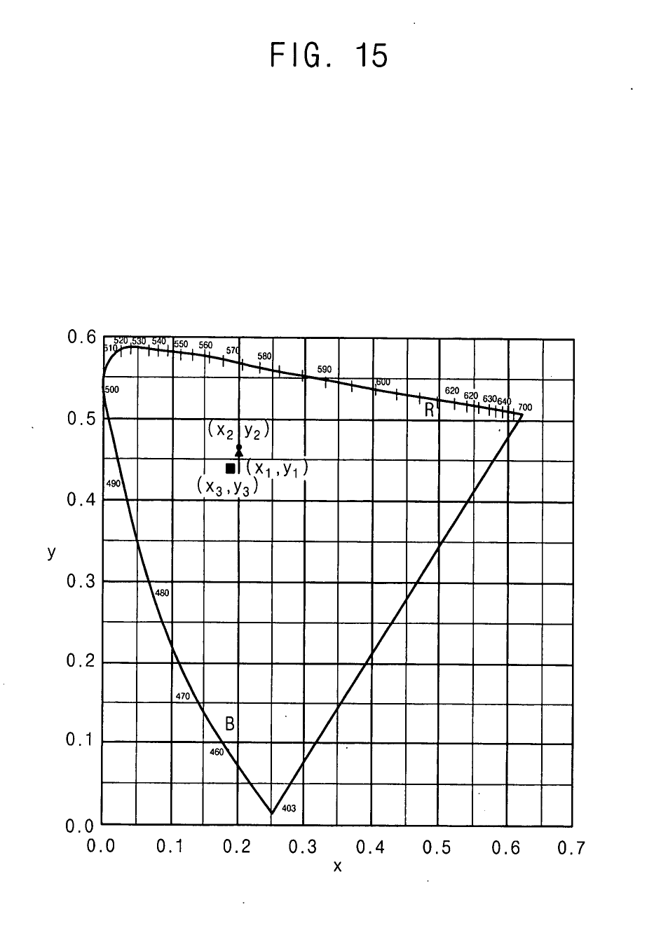

FIG. 14 is a graph showing a chromaticity coordinate in a conventional liquid crystal display apparatus, and FIG. 15 is a graph showing a chromaticity coordinate in a liquid crystal display apparatus according to an exemplary embodiment of the present invention. In FIG. 14 and FIG. 15, a triangular point represents a first chromaticity coordinate (X₁, Y₁) of a light from a light source of CIE standard illuminant D65, which indicates a daylight having a color temperature of about 6504K. A circular point represents a second chromaticity coordinate (X₂, Y₂) of the light that has passed through the first and second polarizing axes, which are substantially parallel with each other, of the first and second polarizing plates, respectively. A square point represents a third chromaticity coordinate (X₃, Y₃) of the light that has passed through the first and second polarizing axes 501 and 601, which are substantially perpendicular to each other, of the first and second polarizing plates 500 and 600, respectively.

Referring to FIG. 14, in the first chromaticity coordinate (X₁, Y₁), a first X coordinate (X₁) is about 0.19, and a first Y coordinate (Y₁) is about 0.46. In the second chromaticity coordinate (X₂, Y₂), a second X coordinate (X₂) is about 0.19, and a second Y coordinate (Y₂) is about 0.47. In the third chromaticity coordinate (X₃, Y₃), a third X coordinate (X₃) is about 0.18, and a third Y coordinate (Y₃) is about 0.38.

As FIG. 15 shows, the third chromaticity coordinate (X₃, Y₃) may change when forming the first absorbing layer 140 between the first and second polarizing plates 500 and 600. Particularly, the third X coordinate (X₃) is about 0.18, and the third Y coordinate (Y₃) is about 0.44. In other words, the third chromaticity coordinate (X₃, Y₃) is closer to the first chromaticity coordinate (X₁, Y₁) when the first absorbing layer 140 is disposed between the first and second polarizing plates 500 and 600.

According to exemplary embodiments of the present invention, the absorbing layer that absorbs light having the wavelength range of about 380 nm to about 480 nm may be disposed between the first and second polarizing plates. Thus, the liquid crystal display apparatus may prevent light leakage, thereby improving the display quality.

Also, since the absorbing layer may planarize the color filter substrate when it is placed between the color filter layer and the common electrode, the liquid crystal display apparatus may not be thicker even though the absorbing layer is formed between the color filter layer and the common electrode.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A color filter substrate, comprising:
a substrate;
a color filter layer on the substrate;
an absorbing layer that is configured to absorb a second light having a wavelength in a wavelength range of a first light is externally provided, the absorbing layer being formed on the color filter layer; and
a common electrode on the absorbing layer.

2. The color filter substrate of claim 1, wherein the wavelength range is about 380 nm to about 480 nm.

3. The color filter substrate of claim 1, wherein the absorbing layer planarizes a surface of the color filter substrate.

4. The color filter substrate of claim 1, wherein the absorbing layer comprises a polymer having liquid crystal characteristics to absorb the second light.

5. The color filter substrate of claim 1, wherein the color filter layer comprises a plurality of color pixels.

6. The color filter substrate of claim 5, further comprising a black matrix between adjacent color pixels.

7. A display apparatus, comprising:
a display panel to display an image;
a first polarizer that is configured to polarize a first light externally provided, the first polarizer being disposed behind the display panel;
a second polarizer that is configured to polarize a second light from the display panel, the second polarizing being disposed in front of the display panel; and
an absorbing layer that is configured to absorb a light having a wavelength in a wavelength range of a polarized first light from the first polarizer, the absorbing layer being disposed between the first polarizer and the second polarizer.

8. The display apparatus of claim 7, wherein the display panel comprises:
a color filter substrate including a first substrate, a color filter layer on the first substrate, the absorbing layer on the color filter layer and a common electrode on the absorbing layer;
an array substrate including a second substrate, a thin film transistor array on the second substrate and a pixel electrode on the thin film transistor array; and
a liquid crystal layer disposed between the color filter substrate and the array substrate.

9. The display apparatus of claim 8, wherein the wavelength range is from about 380 nm to about 480 nm.

10. The display apparatus of claim 8, wherein the absorbing layer planarizes a surface of the color filter substrate.

11. The display apparatus of claim 8, wherein the absorbing layer comprises a liquid crystal material.

12. The display apparatus of claim 7, wherein the display panel comprises:
a color filter substrate including a first substrate, a color filter layer on the first substrate, a planarization layer on the color filter layer and a common electrode on the planarization layer;
an array substrate including a second substrate, an absorbing layer on the second substrate, a thin film transistor array on the absorbing layer and a pixel electrode on the thin film transistor array; and
a liquid crystal layer disposed between the color filter substrate and the array substrate.

13. The display apparatus of claim 12, wherein the array substrate further comprises a passivation layer between the absorbing layer and the thin film transistor array.

14. The display apparatus of claim 7, wherein the absorbing layer is disposed between the display panel and the second polarizer.

15. The display apparatus of claim 14, wherein the absorbing layer is coated on an upper surface of the display panel.

16. The display apparatus of claim 14, wherein the absorbing layer is coated on a lower surface of the second polarizer.

17. The display apparatus of claim 7, wherein the first polarizer has a first polarizing axis to absorb a portion of the first light and the second polarizer has a second polarizing axis to absorb a portion of the second light.

18. The display apparatus of claim 17, wherein the first polarizing axis is substantially perpendicular to the second polarizing axis.

19. A display apparatus, comprising;
a color filter substrate including a first substrate, a color filter layer on the first substrate and a common electrode on the color filter layer;
an array substrate including a second substrate, a thin film transistor array on the second substrate and a pixel electrode on the thin film transistor array;
a first liquid crystal layer disposed between the common electrode and the pixel electrode; and
a second liquid crystal layer disposed between the first substrate and the second substrate to absorb a light having a wavelength in a wavelength range.

20. The display apparatus of claim 19, wherein the wavelength range is from about 380 nm to about 480 nm.

21. The display apparatus of claim 19, wherein the second liquid crystal layer is disposed between the color filter layer and the common electrode.

22. A method for manufacturing a color filter substrate, the method comprising:
forming a color filter layer on a substrate corresponding to a color area;
forming an absorbing layer on the color filter layer to absorb a light having a wavelength in a wavelength range; and
forming a common electrode on the absorbing layer.

23. The method of claim 22, wherein forming the absorbing layer comprises:
providing a liquid crystal material onto a first end portion of the substrate on which the color filter layer is formed; and
applying stress to the liquid crystal material to form the absorbing layer having a flat surface.

24. The method of claim 22, further comprising forming a black matrix on the substrate corresponding to a blocking area except for the color area.

25. A method for manufacturing a display apparatus, the method comprising:
forming a color filter substrate including a first substrate, a color filter layer on the first substrate and a common electrode on the color filter layer;
forming an array substrate including a second substrate, a thin film transistor array on the second substrate and a pixel electrode on the thin film transistor array;
forming a liquid crystal layer between the common electrode and the pixel electrode; and
forming an absorbing layer between the first substrate and the second substrate to absorb a light having a wavelength in a wavelength range.

26. The method of claim 25, wherein the absorbing layer is formed between the color filter layer and the common electrode.
